(19) United States
(12) Patent Application Publication
(10) Pub. No.: US 2005/0157397 A1
(43) Pub. Date: Jul. 21, 2005

(54) Wide-angle polarization-independent narrow-band spectral filter and method

(76) Inventors: Oleg M. Efimov, Newbury Park, CA (US); Alexander A. Betin, Manhattan Beach, CA (US)

Correspondence Address: John E. Gunther;Raytheon Company, P.O. Box 902 (E1/E150), El Segundo, CA, 90245-0902, US

(21) Appl. No.: 10/761,720

(22) Filed: Jan. 20, 2004

(51) Int. Cl. G02B 27/14

(52) U.S. Cl. 359/629

(57) ABSTRACT

An optical arrangement (10) comprising a first beam splitter (12) for transmitting light of a first polarization, to provide a first beam, and reflect light of a second polarization; a first spectral filter (16) in optical alignment with the first beam, the filter (16) being adapted to return a second beam thereto; and a first polarization rotator (14) in optical alignment with the beam splitter (12) and the spectral filter (16) for effecting a rotation of the polarization of the second beam relative to the first beam whereby the second beam has the second polarization and is reflected by the beam splitter (12). In a specific implementation, the spectral filter (12) may be a Bragg grating, a quarter-wave plate (22), a Faraday rotator (32) or other suitable device. If a Faraday rotator is used, a polarization adjuster (34) is used in optical alignment therewith. A number of alternative embodiments are disclosed. In a first alternative embodiment, a second polarization rotator (44) is disposed in optical alignment with the first beam splitter (12) for effecting a rotation of the polarization of the light reflected from the beam splitter (12) to provide a third beam. In one variant a second spectral filter (48) is disposed in alignment with the second polarization rotator (44). In another variant, the first spectral filter (52) is adapted to receive the third beam. In another embodiment, a second beam splitter (68) is disposed between the second Faraday rotator (64) and the spectral filter (16).

### BACKGROUND OF THE INVENTION

1. Field of the Invention

The present invention relates to optics. More specifically, the present invention relates to narrow band spectral filters.

2. Description of the Related Art

Narrow-band filtration of optical radiation is a necessary component of applications in many areas, e.g.: 1) in optical communication, as narrow-band WDM add/drop filters, gain-flattening filter, etc.; 2) in spectroscopy, to select a specific narrow spectral region; 3) in systems of remote measurements and diagnostics such as LIDAR or LADAR; and 4) in astronomy and in other fields. Until now, thick Bragg gratings and Fabri-Perot interference filters have been used to design the extremely narrow-band spectral filters for these applications.

In accordance with the well-known Kogelnik's coupled wave theory the narrowest spectral band is reached for a reflective grating when the angle of beam incidence is close to normal. (See H. Kogelnik, “Coupled Wave Theory For Thick Hologram Gratings,” The Bell System Technical Journal, v.48, pp. 2909-2945, 1969.) Therefore, to get very high spectral sensitivity, the thick Bragg gratings are designed to operate in a reflective mode and are placed in the schemes at the smallest possible angles to the optical axes just enough to separate the incident and reflected beams. However, the angular bandwidth of reflection Bragg gratings is very sensitive to the incident angle. Even at small incident angles angular bandwidth may drop substantially from the maximal value corresponding to the normal incidence.

Fabri-Perot interference filters are also very sensitive to the angle of incidence of the incoming beam. They have a quite strong spectral band shift with angle. Therefore, narrow-band interference filters as well as thick Bragg gratings should be preferably used in applications with collimated or near collimated beams.

Unfortunately, there a number of practical applications in which a strong angular selectivity is not desirable because it may lead to performance degradation or place difficult requirements on practical designs caused by vibrations of optical setups, deformations of filters, imperfections and aberrations of real beams after passing through the atmosphere or through optical systems.

Hence, a need exists in the art for narrow band spectral filters with a wide angular capability.

### SUMMARY OF THE INVENTION

The need in the art is addressed by the optical arrangement of the present invention. Generally, the inventive arrangement comprises a first beam splitter for transmitting light of a first polarization, to provide a first beam, and reflect light of a second polarization; a first spectral filter in optical alignment with the first beam, the filter being adapted to return a second beam thereto; and a first polarization rotator in optical alignment with the beam splitter and the spectral filter for effecting a rotation of the polarization of the second beam relative to the first beam whereby the second beam has the second polarization and is reflected by the beam splitter.

In a specific implementation, the spectral filter may be a Bragg grating, an interference filter, a multilayer coating, or any other spectral filter working in a reflection mode (e.g., a transmitting filter in combination with back reflecting mirror), a quarter-wave plate, a Faraday rotator or other suitable device without departing from the scope of the present teachings. If a Faraday rotator is used, a polarization adjuster is used in optical alignment therewith.

A number of alternative embodiments are disclosed. In a first alternative embodiment, a second polarization rotator is disposed in optical alignment with the first beam splitter for effecting a rotation of the polarization of the light reflected from the beam splitter to provide a third beam. In one variant a second spectral filter is disposed in alignment with the second polarization rotator. In another variant, the first spectral filter is adapted to receive the third beam.

In another embodiment, a second beam splitter is disposed between the second Faraday rotator and the spectral filter. Polarization adjusters may be used as necessary to compensate for errors in the rotation of the polarization effected by the Faraday rotators.

The narrow-band spectral filter proposed in this invention is a filter allowing the use a reflection narrow-band spectral filter, including the etalons and reflection Bragg gratings, recorded in thick samples of photosensitive materials, under conditions of normal incidence together with a capability to provide an easy geometrical separation of the reflected/diffracted beam from the incident beam. Such filters can combine an extremely high spectral selectivity with rather low sensitivity to angular deviations in any direction. It is important that these filters are polarization insensitive and capable to work with arbitrary polarization of the incident beams.

### BRIEF DESCRIPTION OF THE DRAWINGS

FIG. 1 shows an optical arrangement adapted to provide a wide-angle, narrow-band filter for linear polarized beams in accordance with an illustrative embodiment of the teachings of the present invention.

FIG. 2 shows an alternative embodiment of the inventive arrangement in which the rotator is implemented with quarter-wave plate.

FIG. 3 shows another implementation that uses a combination of a Faraday rotator and a polarization adjuster as a polarization rotation element in accordance with the teachings of the present invention.

FIG. 4 shows an arrangement of a wide-angle, narrow-bandwidth spectral filter designed for arbitrarily polarized beams in accordance with an illustrative embodiment of the present teachings.

FIG. 5 shows a variant of the embodiment of FIG. 4 with a single spectral filter sized and positioned to receive beams from each of two polarization rotation elements in accordance with the present teachings.

FIG. 6 shows another embodiment of the optical arrangement of the present invention with dual paths, dual beam splitters and a single spectral filter.

FIG. 7 is a variation on FIG. 6 with polarization adjusters.

### DESCRIPTION OF THE INVENTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

One teaching of the present invention is to utilize polarization rotation techniques in order to realize a near zero incident angle spectral filter with a simultaneous capability to easily and completely separate the diffracted (reflected) beam from the incident beam. The invention is best understood with initial reference to a simple embodiment of a wide-angle narrow-band spectral filter capable to work with linear polarized incident beams.

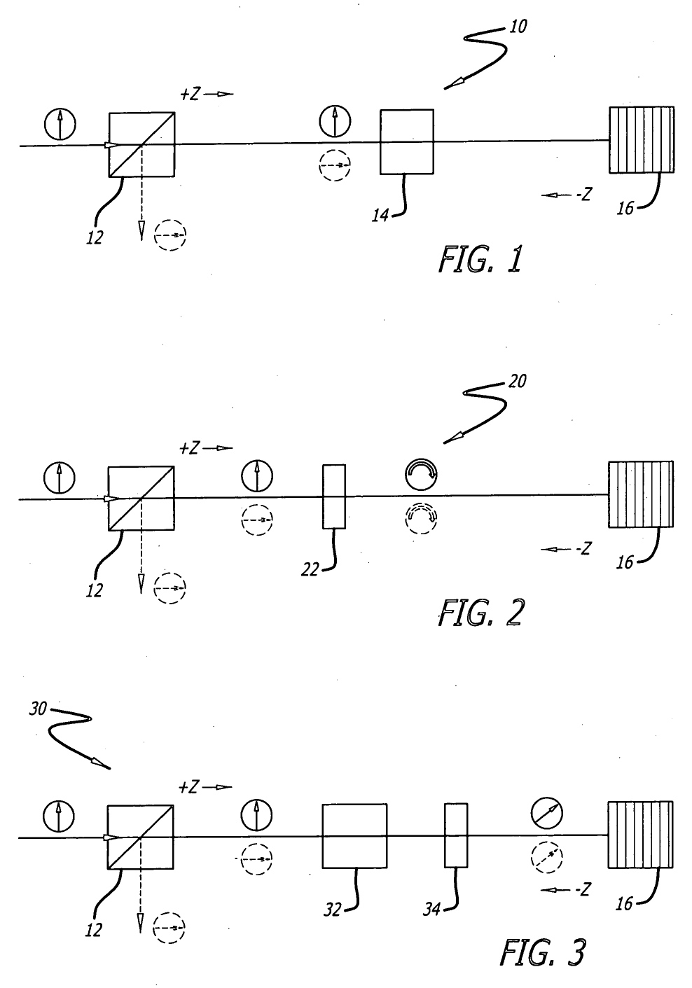

FIG. 1 shows an optical arrangement adapted to provide a wide-angle, narrow-band filter for linear polarized beams in accordance with an illustrative embodiment of the teachings of the present invention. FIG. 1 shows an exemplary implementation of an arrangement 10 in which a linear polarized incident beam enters from the left and travels in a +Z direction through a polarization beam splitter 12 of conventional design and construction. (In FIG. 1, the orientation of the polarization is designated with an arrow inside a circle. Note, that the polarization orientation of the incident beam may be adjusted for the best transmission through the beam splitter.) The beam then moves through a polarization rotating element 14 and then gets reflected from a narrow-band spectral filter 16. The spectral filter may be implemented with a Bragg grating or other device suitable for a given application without departing from the scope of present teachings. The beam then travels in the backward −Z direction. After passing back through the polarization rotator 14 the beam stays linear polarized but the polarization state is rotated 90 degrees relative to that transmitted by the beam splitter 12. The result is that the return beam gets completely reflected down by the polarization beam splitter 12 in a near perpendicular direction relative to the incident beam. The polarization rotator 14 can be implemented in at least two ways.

FIG. 2 shows an alternative embodiment of the inventive arrangement 20 in which the rotator 14 is implemented with quarter-wave plate 22. In this case, the linear polarized incident beam becomes circular polarized on its first pass through the quarter-wave plate 22. The beam is then reflected from the spectral filter 16. The return beam, having the same circular polarization, will become linear polarized again after passing back through the quarter-wave plate 22 but the polarization will flip to an angle near 90 degrees. The return beam with orthogonal polarization then is reflected from the polarization beam splitter 12 near 90 degrees relative to the direction of the incident beam. The angle of polarization rotation can be adjusted by rotating the quarter-wave plate 22 to give the maximum reflection of the return beam from the beam splitter 12.

FIG. 3 shows another implementation 30 that uses a combination of a Faraday rotator 32 and a polarization adjuster 34 as a polarization rotation element in accordance with the teachings of the present invention. Those skilled in the art will appreciate that the Faraday rotator works in a similar manner as a Faraday isolator. The Faraday rotator 32 rotates the polarization 45 degrees when the beam travels in the +Z direction and then continues rotation another 45 degrees when the beam reflected from the spectral filter 16 travels back in −Z direction. The resulting polarization flips 90 degrees thus providing a complete reflection and separation of the return beam at the beam splitter 12. If the Faraday rotator does not provide a sufficiently accurate polarization rotation, the polarization adjuster 34 serves to the polarization orientation of the beam input to the spectral filter 16 in order to adjust the net polarization rotation of the return beam to achieve a maximum reflectivity of the return beam at the beam splitter 12. The polarization adjuster 34 can be implemented as a polarizing prism/wedge or cube. The polarization adjuster can be implemented in combination with a half-wave plate (or any other reciprocal polarization rotator).

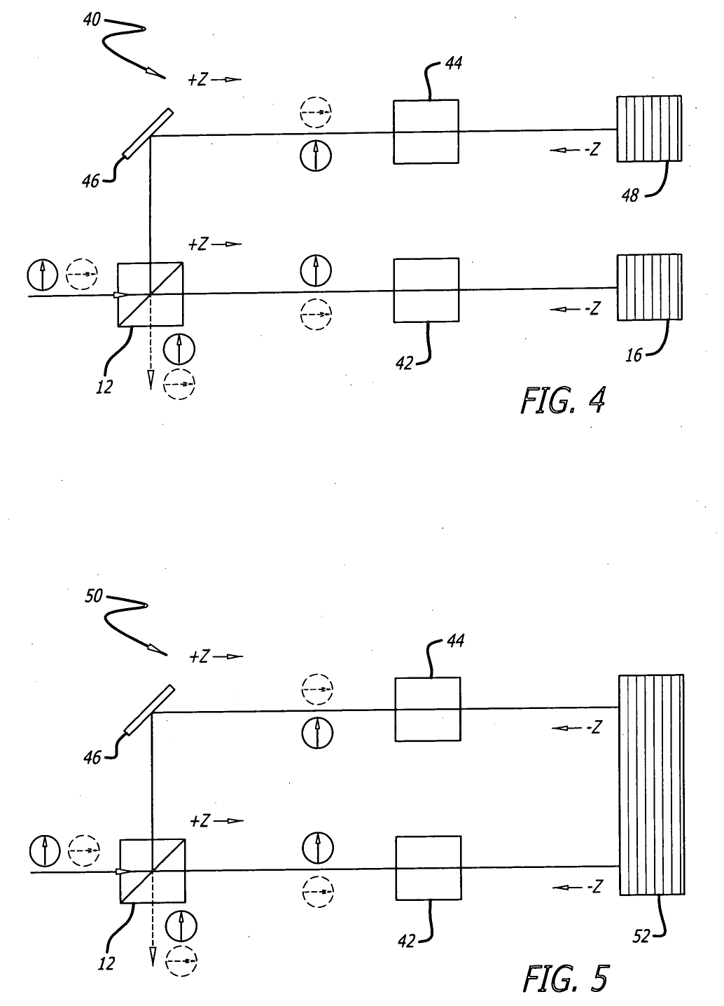

FIG. 4 shows an arrangement 40 of a wide-angle, narrow-bandwidth spectral filter designed for arbitrarily polarized beams in accordance with an illustrative embodiment of the present teachings. In this embodiment, the beam splitter 12 splits the unpolarized incoming beam into two linear polarized components. The beam from the reflected polarization component is directed by a fold mirror along a second path. The fold mirrors used herein are optional and, as will be appreciated by those skilled in the art, these mirrors can be disposed in any location in the optical train that may be optimal for a given application.

Each component travels along its own path, as above, through first and second polarization rotation elements 42 and 44. In this embodiment, each beam, in each path, reflects from a spectral filter 16 or 48 and then returns back with its polarization rotated 90 and thereby deflects and separates from the incoming beam at the beam splitter 12 as above.

The implementation as depicted on FIG. 4 requires two separate spectral filters 16 and 48, or one much larger (at least twice) in size for both beams simultaneously as depicted in the embodiment 50 of FIG. 5. However, this may not be convenient, reliable and/or practical.

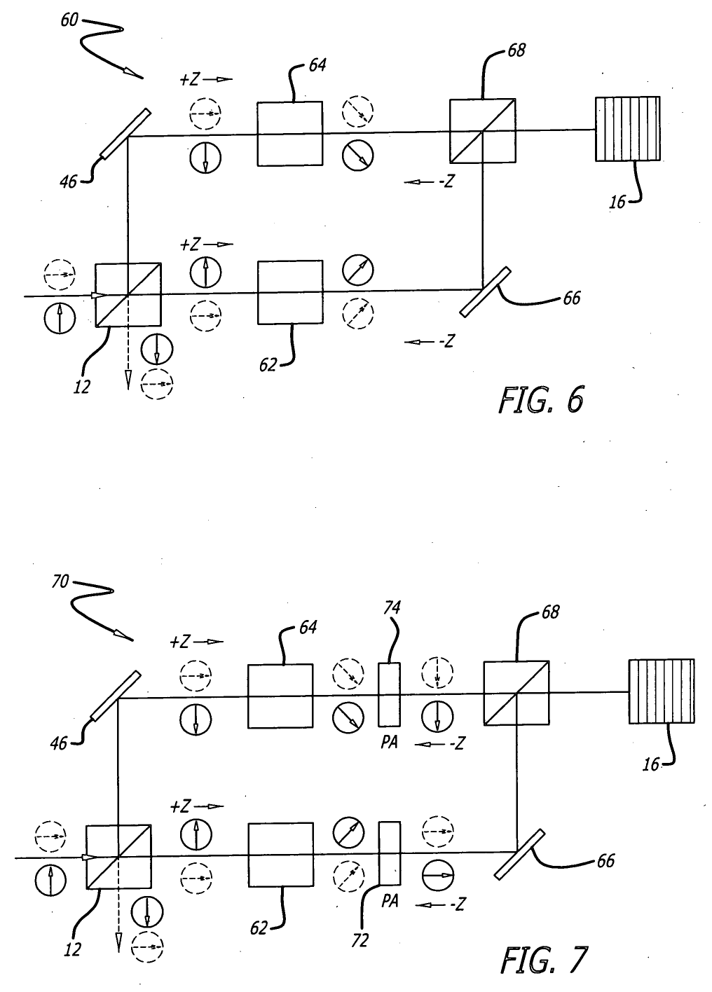

FIG. 6 shows another embodiment of the optical arrangement of the present invention. The arrangement 60 of FIG. 6 uses only one spectral filter 16. Here the unpolarized incoming beam splits at beam splitter 12 into two beams. These two linear polarized components travel along separate paths through first and second Faraday rotators 62 and 64 respectively, each getting 45° of polarization rotation therefrom. Then, at a second beam splitter 68 aligned to work with beams having 45° rotated, one beam transmits straight through the beam splitter 68 and the other beam is (orthogonally polarized) reflected so that the two beams combine into one beam heading towards the spectral filter 16. Both beams are reflected from the common spectral filter (Bragg grating) 16 independently. The beams then follow their return paths and have their polarizations rotated another 45° for a total of 90° of rotation relative to the polarization of each beam as it exits the first beam splitter 12. Finally, the beams combine again and exit at the first beam splitter 12 as one unpolarized beam. In this embodiment, polarization adjusters may be used with Faraday rotators. In this embodiment, the polarization adjusters 72 and 74 can be implemented with half-wave plates (or any other reciprocal polarization rotator) in order to facilitate alignment and the performance optimization.

Note, in all considered optical schemes, a normal incident angle is used at the spectral filter, thus maximizing the filter's performance. Therefore, the maximum available angular field of view is utilized together with the narrowest spectral region.

The inventive schemes allow grating operation in the most attractive region for spectral application (around the normal incidence of the beam) and utilization of substantially all of the power of the incoming beam regardless of the beam polarization. One more important consequence is that the filters operate symmetrically in all directions. A wider angular field of view can be achieved for Bragg gratings (as spectral filters) using photosensitive materials with a higher refractive index such as LiNbO₃.

Of course, the present teachings offer wide general use and a broad range of potential applications. The teachings are most applicable where a narrow bandwidth spectral filter is needed with the least sensitivity to the incident angle.

Thus, the present invention has been described herein with reference to a particular embodiment for a particular application. Those having ordinary skill in the art and access to the present teachings will recognize additional modifications applications and embodiments within the scope thereof.

It is therefore intended by the appended claims to cover any and all such applications, modifications and embodiments within the scope of the present invention.

Accordingly,

1. An optical arrangement comprising:
a first beam splitter for transmitting light of a first polarization, to provide a first beam, and reflect light of a second polarization;
a first spectral filter in optical alignment with said first beam, said filter being adapted to return a second beam thereto; and
a first polarization rotator in optical alignment with said beam splitter and said spectral filter for effecting a rotation of the polarization of said second beam relative to said first beam whereby said second beam has said second polarization and is reflected by said beam splitter.

2. The invention of claim 1 wherein said spectral filter is a Bragg grating.

3. The invention of claim 1 wherein said spectral filter is an interference filter.

4. The invention of claim 1 wherein said spectral filter is a multilayer coating.

5. The invention of claim 1 wherein said spectral filter is designed to operate in reflection mode.

6. The invention of claim 5 wherein said spectral filter includes a transmitting filter operationally coupled to a back reflecting mirror.

7. The invention of claim 1 wherein said polarization rotator is a quarter-wave plate.

8. The invention of claim 1 wherein said polarization rotator is a Faraday rotator.

9. The invention of claim 8 further including a polarization adjuster in optical alignment with said rotator.

10. The invention of claim 8 further including a second polarization rotator in optical alignment with said first beam splitter for effecting a rotation of the polarization of said light reflected from said beam splitter to provide a third beam.

11. The invention of claim 10 further including a second spectral filter in alignment with said second polarization rotator.

12. The invention of claim 11 further including a fold mirror disposed between the beam splitter and said second polarization rotator.

13. The invention of claim 10 wherein said first spectral filter is adapted to receive said third beam.

14. The invention of claim 10 wherein said first and second rotators are Faraday rotators.

15. The invention of claim 14 further including a second beam splitter disposed between said second Faraday rotator and said spectral filter.

16. The invention of claim 15 further including a first fold mirror disposed between the first beam splitter and said second polarization rotator.

17. The invention of claim 16 further including a second fold mirror disposed between the first polarization rotator and the second beam splitter.

18. The invention of claim 15 further including a first polarization adjuster disposed between said second Faraday rotator and said spectral filter.

19. The invention of claim 18 further including a second polarization adjuster disposed between said first Faraday rotator and said fold mirror.

20. The invention of claim 15 wherein said spectral filter is a Bragg grating.

21. An optical arrangement comprising:
a first beam splitter for transmitting light of a first polarization, to provide a first beam, and reflect light of a second polarization;
a first polarization rotator in optical alignment with said first beam splitter;
a second polarization rotator in optical alignment with said first beam splitter;
a second beam splitter in optical alignment with said first and said second polarization rotators; and
a spectral filter in optical alignment with said second beam splitter.

22. The invention of claim 21 wherein said spectral filter is a Bragg grating.

23. The invention of claim 21 wherein said polarization rotators are Faraday rotators.

24. The invention of claim 23 further including polarization adjusters in optical alignment with said rotators.

25. The invention of claim 21 further including a first fold mirror disposed between said first beam splitter and said second polarization rotator.

26. The invention of claim 25 further including a second fold mirror disposed between said first rotator and said second beam splitter.

27. The invention of claim 26 further including a first polarization adjuster disposed between said first Faraday rotator and said second beam splitter.

28. The invention of claim 27 further including a second polarization adjuster disposed between said second Faraday rotator and said second beam splitter.

29. A filtering method including the steps of:
splitting an incident beam of electromagnetic energy into first and second beams with a beam splitter, said first beam having a first polarization;
applying said first beam to a spectral filter, said filter providing a return beam in response thereto; and
rotating the polarization of said return beam relative to said first beam and applying said polarization rotated return beam to the beam splitter whereby said beam splitter directs the return beam off-axis relative to the incident beam.
